(19) United States
(12) Patent Application Publication
(10) Pub. No.: US 2016/0006006 A1
(43) Pub. Date: Jan. 7, 2016

(54) BATTERY MODULE

(71) Applicant: SANYO ELECTRIC CO., LTD., Daito-shi, Osaka (JP)

(72) Inventors: SHINYA MOTOKAWA, Osaka (JP); TOMOHIKO YOKOYAMA, Osaka (JP)

(21) Appl. No.: 14/766,781

(22) PCT Filed: Feb. 10, 2014
(86) PCT No.: PCT/JP2014/000690

§ 371 Date: Aug. 10, 2015

(30) Foreign Application Priority Data
Feb. 14, 2013 (JP) 2013-027095
Mar. 6, 2013 (JP) 2013-044025

(51) Int. Cl. H01M 2/10; H01M 2/12

(52) U.S. Cl. CPC H01M 2/1077; H01M 2/1223; H01M 2200/20

(57) ABSTRACT

Battery module includes a plurality of battery blocks, and connecting member for aligning and connecting the plurality of battery blocks in a predetermined arrangement direction. Each of battery blocks includes the following elements: a plurality of batteries longitudinally aligned with each other; battery case for arranging and holding the plurality of batteries; lid as a positive electrode-side insulating lid, disposed at positive electrode-side ends of batteries in battery case, for insulating positive electrodes of the batteries from positive electrode current collecting plate; lid as a negative electrode-side insulating lid, disposed at negative electrode-side ends of batteries in battery case, for insulating negative electrodes of batteries from a negative electrode current collecting plate; and at least a pair of guide grooves disposed on lid and extending in a direction parallel to each other. A pair of sliding parts provided to the connecting member is fitted into guide grooves.

### TECHNICAL FIELD

The present invention relates to a battery module in which a plurality of battery blocks is arranged.

### BACKGROUND ART

To obtain a desired voltage and current, a battery block configured by connecting a plurality of batteries is used, and further a battery module configured by connecting a plurality of battery blocks is used.

Patent Literature 1 describes a structure of casing members for holding batteries so as to stack planar square battery cells in a plurality of stages so that the wider faces of the cells are opposite to each other. In the round holes at the four corners of one of the casing members, each of two round holes diagonally opposite to each other has an H longitudinal sectional shape and has no female screw threaded therein. Each of the other two round holes has a square longitudinal sectional shape and has a female screw threaded therein. Here, when individual stages are stacked, one of the casing members is turned over. Thus, the round holes in the H longitudinal sectional shape face the round holes in the square longitudinal sectional shape. By threading a bolt through the facing round holes, the stages are fixed sequentially.

Patent Literature 2 discloses the following configuration as a battery box for a battery pack. A plurality of lines of batteries disposed in a landscape orientation is stacked in a plurality of stages in the height direction between a base plate and a cover plate. Further, the plurality of lines of batteries disposed in individual stages is fixed, using a pair of interposing bars disposed parallel to the base plate.

### CITATION LIST

### Patent Literature

PTL 1: Japanese Patent Unexamined Publication No. 2010-108734
PTL 2: Japanese Patent Unexamined Publication No. 2007-234369

### SUMMARY OF THE INVENTION

### Technical Problem

In a battery module, a plurality of battery blocks needs to be connected, arranged and fixed with a simple configuration.

### Solutions to Problems

A battery module in accordance with an exemplary embodiment of the present invention includes a plurality of battery blocks, and a connecting member for aligning and connecting the plurality of battery blocks in a predetermined arrangement direction. Each of the battery blocks includes the following elements: a plurality of batteries longitudinally aligned with each other; a battery case for arranging and holding the plurality of batteries; an insulating lid disposed at the positive electrode-side ends or the negative electrode-side ends of the batteries in the battery case; and at least a pair of guide grooves disposed on the insulating lid and extending in a direction parallel to each other so that at least a pair of sliding parts provided to the connecting member is fitted into the guide grooves. The plurality of battery blocks is aligned in the direction in which each of the guide grooves extends, and the sliding parts of the connecting member are fitted into the corresponding guide grooves of the plurality of battery blocks. Thereby, the sliding parts and the guide grooves are interconnected.

A battery module in accordance with another exemplary embodiment of the present invention includes a plurality of battery blocks, a plurality of cover members, and a fixing member for fixing the plurality of cover members through the plurality of cover members. Each of the battery blocks has a plurality of batteries each having a cylindrical external shape. The plurality of batteries is aligned in the longitudinal direction of the batteries and has a through part including no batteries. The through part extends from one side to the other side along the longitudinal direction of the batteries at both ends of a line arrangement direction of the plurality of batteries. When the plurality of battery blocks is arranged so that the direction parallel to the longitudinal direction of the batteries is the arrangement direction of the battery blocks, the plurality of cover members is disposed at both ends of the corresponding battery blocks along the arrangement direction of the battery blocks. The plurality of battery blocks is arranged so that the positions of the through parts are aligned along the arrangement direction of the battery blocks. The fixing member is disposed along each through part of the plurality of battery blocks.

### Advantageous Effect of Invention

A battery module of the present invention allows a plurality of battery blocks to be connected, arranged, and fixed with a simple configuration.

### BRIEF DESCRIPTION OF DRAWINGS

FIG. 1 is a perspective view of a battery module in which battery blocks are disposed in an X direction in accordance with an example of a first exemplary embodiment of the present invention. In FIG. 1, (a) shows a battery module, (b) shows a battery block, (c) shows a battery assembly, and (d) shows a connecting member.

FIG. 2 is a sectional view taken in a plane perpendicular to the X direction of FIG. 1(a).

FIG. 3 is a sectional view taken in a plane perpendicular to the X direction, similarly to FIG. 2, in another configuration example of a battery module in accordance with an example of the first exemplary embodiment of the present invention.

FIG. 4 is a perspective view of a battery module in which battery blocks are disposed in a Y direction in accordance with an example of the first exemplary embodiment.

FIG. 5 is a perspective view of a battery module in which battery blocks are disposed in a Z direction in accordance with an example of the first exemplary embodiment.

FIG. 6 is a diagram showing another configuration of a connecting member in a battery module in accordance with an example of the first exemplary embodiment.

FIG. 7 is a sectional view taken in a plane perpendicular to the X direction, similarly to FIG. 2 and FIG. 3, in another configuration example of a battery module in accordance with an example of the first exemplary embodiment.

FIG. 8 is a perspective view of a battery module in accordance with an example of a second exemplary embodiment of the present invention. In

FIG. 8.(a) shows a battery module and (b) shows a battery block.

FIG. 9 is a sectional view seen from an A direction.

FIG. 10 is a drawing showing a fixing member in accordance with the example of the second exemplary embodiment of the present invention.

FIG. 11 is a drawing showing another configuration of a fixing member in accordance with an example of the second exemplary embodiment.

### DESCRIPTION OF EMBODIMENTS

### First Exemplary Embodiment

Hereinafter, a detailed description of the first exemplary embodiment of the present invention is provided with reference to the accompanying drawings. The material, dimension, shape, the number of batteries, the number of battery blocks, or the like described below is only an example for description, and may be changed appropriately for the specifications of the battery block and the battery module. In the following description, the corresponding elements in all the drawings have the same reference marks and the descriptions of those elements are omitted.

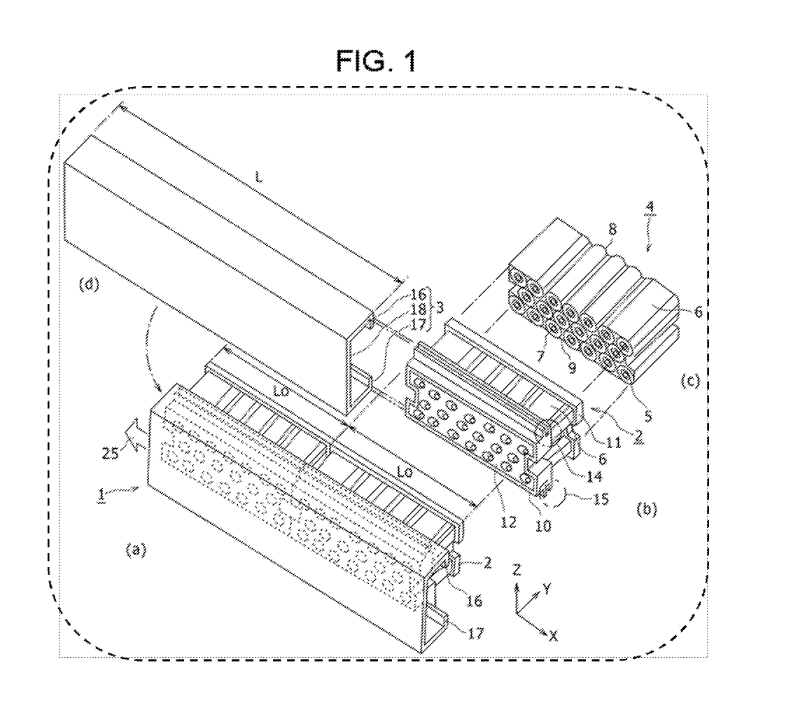

FIG. 1 is a perspective view showing battery module 1, battery block 2 and connecting member 3 that form battery module 1, and battery assembly 4 that forms battery block 2. In FIG. 1, (a) shows battery module 1, (b) shows one battery block 2, (c) shows battery assembly 4, and (d) shows connecting member 3. Battery module 1 is configured of a plurality of battery blocks 2 and connecting member 3. Here, two battery blocks 2 and one connecting member 3 are shown. Each battery block 2 includes battery assembly 4, and each battery assembly 4 has a plurality of batteries 5 aligned with each other. Hereinafter, descriptions are provided for the configurations of battery 5, battery assembly 4, battery block 2 and connecting member 3, and battery module 1 in this order.

FIG. 1 shows an X direction, a Y direction, and a Z direction orthogonal to each other. The direction in which battery blocks 2 are disposed and connecting member 3 extends is the X direction. The Y direction is a longitudinal direction of each of batteries 5 where the plurality of batteries 5 is longitudinally aligned with each other in battery assembly 4. The Z direction is a direction perpendicular to both of the X direction and the Y direction and corresponds to the height direction of connecting member 3. Thus, the XZ plane is an arrangement plane of the plurality of batteries 5. The X direction is one of the directions in which the arrangement plane extends when a plurality of arrangement planes is made into one. As described hereinafter, the direction in which a larger number of batteries 5 are placed in the arrangement plane is defined as the X direction in which connecting member 3 extends. However, connecting member 3 may extend in the direction in which a smaller number of batteries 5 are placed in the arrangement plane.

Battery assembly 4 is configured so that a plurality of batteries 5 is arranged and held in battery case 6. In the example shown in FIG. 1(c), 20 batteries 5 are held in one battery case 6. Each of batteries 5 is a rechargeable/dischargeable secondary battery. As the secondary battery, a lithium ion battery is used. Other examples include a nickel-metal hydride battery and an alkali battery. As shown in FIG. 1(c), the 20 batteries 5 are arranged in a hound's-tooth pattern (a staggered (zigzag) pattern), which minimizes the space between adjacent batteries 5. The plurality of batteries 5 may be disposed in other positional relations.

Batteries 5 are longitudinally aligned with each other in a plurality of lines and in a plurality of columns. When the direction in which a larger number of batteries are disposed is defined as a line direction, the direction in which six or seven batteries 5 are disposed is the line direction and the direction in which three batteries 5 are disposed is the column arrangement direction in FIG. 1(c). The line direction is a direction parallel to the X direction. The column direction is a direction parallel to the Z direction.

In both ends of each battery 5 in the longitudinal direction, one end is used as positive electrode terminal 7 and the other end is used as negative electrode terminal 8. In FIG. 1(c), positive electrode terminals 7 of batteries 5 are arranged on the side closer to the viewer of the drawing. Negative electrode terminals 8 are not shown because the negative electrode terminals are behind batteries 5 in FIG. 1(c). Each of batteries 5 has a cylindrical external shape. An example of cylindrical battery 5 is a lithium ion battery in which the diameter is 18 mm, the height is 65 mm, the voltage between terminals is 3.6 V, and the capacity is 2.5 Ah. This is an example for description, and the battery may have different dimensions and characteristic values. The shape of the battery is not limited to a cylindrical one and may have a square shape.

Battery 5 has safety valve 9. Safety valve 9 is a mechanism for releasing exhaust gas from the inside to the outside of battery 5 when the pressure of the gas generated by the electrochemical reaction performed inside battery 5 exceeds a predetermined threshold pressure. Safety valve 9 is provided one of both ends in the longitudinal direction of battery 5. In the example shown in FIG. 1, the safety valve is provided on the side of positive electrode terminal 7, but may be provided on the side of negative electrode terminal 8. In the following example, safety valve 9 is provided on the side of positive electrode terminal 7. Thus, safety valves 9 of batteries 5 are arranged on the positive electrode side of battery block 2, and the exhaust gas from the inside of batteries 5 is exhausted from the gas exhaust outlets of safety valves 9 arranged on the positive electrode side of battery block 2.

Case 6 is a holding container for arranging and holding the 20 batteries 5 in a predetermined positional relation. Case 6 is a frame body that has 20 battery holding parts with an opening at both ends in the height direction. Each of batteries 5 is disposed and held in one of the battery holding parts. Examples of such battery case 6 include a case made of aluminum, for example, into a predetermine shape by extrusion molding.

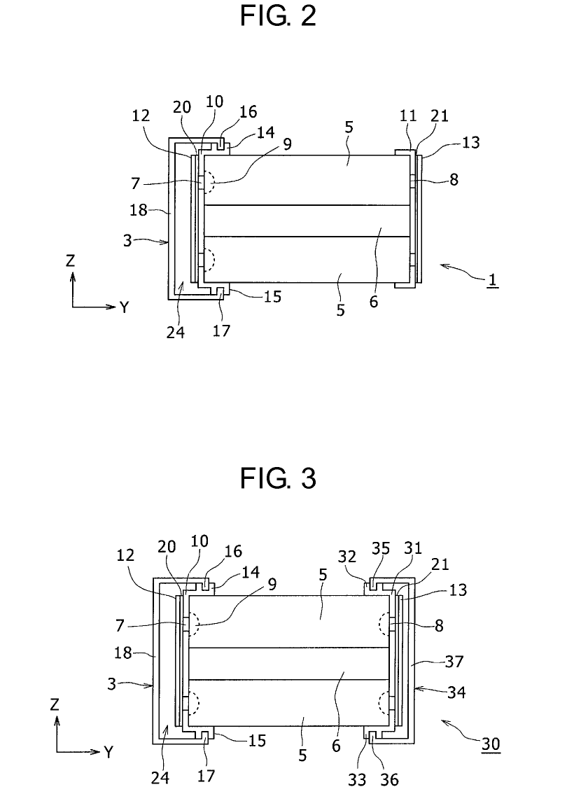

Battery block 2 is configured so that both ends of battery case 6 that holds the 20 batteries 5 are covered with insulating lids 10, 11. Lid 10 is a positive electrode-side insulating lid disposed at the positive electrode-side ends of batteries 5 in battery case 6. Positive electrode current collecting plate 12 that connects the positive electrode terminals of the 20 batteries 5 in parallel is attached to the positive electrode-side insulating lid. The positive electrode-side insulating lid insulates individual positive electrode terminals 7 of the 20 batteries from positive electrode current collecting plate 12. Lid 11 is a negative electrode-side insulating lid disposed at the negative electrode-side ends of batteries 5 in battery case 6. Negative electrode current collecting plate 13 that connects negative terminals 8 of the 20 batteries 5 in parallel is attached to the negative electrode-side insulating lid (see FIG. 2). The negative electrode-side insulating lid insulates the individual negative electrode terminals of the 20 batteries 5 from negative electrode current collecting plate 13.

Examples of such lids 10, 11 include plastic material that has heat resistance and electrically insulating property and is formed into a predetermined shape. Examples of the plastic material include polyethylene terephthalate, polyimide, polysulfone, polyethersulfone, polyetherimide, polyphenylene sulfide, polyetheretherketone, polycarbonate, reformed polyphenylene ether, and polybutylene terephthalate.

A pair of guide grooves 14, 15 provided to battery block 2 is used as guiding grooves along which connecting member 3 slides. The pair of guide grooves 14, 15 is integrally formed with lid 10, which is a positive electrode-side insulating lid. The pair of guide grooves 14, 15 is provided at corresponding ends of lid 10 along the Z direction, and extends in the direction parallel to each other. The extending direction is a direction in which connecting member 3 extends, which is the X direction. The opening directions of the pair of grooves 14, 15 are opposite to each other along the Z direction. Namely, the opening of guide groove 14 provided on the upper side of lid 10 in the Z direction is oriented to the upper side. The opening of guide groove 15 provided on the lower side of lid 10 in the Z direction is oriented to the lower side.

For instance, examples of such a pair of guide grooves 14, 15 can be made into groove shapes when lid 10 is formed into a predetermined shape. Alternatively, a guide member having a groove shape is prepared as a separate member, and may be integrated into lid 10 by adhesion or a suitable fixing measure. When a guide member including guide grooves 14, 15 is used, the guide member is formed of an insulating material similar to that of lid 10.

Connecting member 3 is a member that integrates and connects a plurality of battery blocks 2, when the battery blocks are disposed in the X direction. Connecting member 3 includes the following elements: a pair of sliding parts 16, 17 sliding along the pair of guide grooves 14, 15 of battery block 2, respectively, and fitted therein; and cover part 18 interconnecting the pair of sliding parts 16, 17. Cover part 18 is configured of the ceiling wall extending in the Z direction, and two side walls extending from both ends of the ceiling in the Y direction. The sectional shape taken in the direction perpendicular to the X direction is a horizontally-inverted C shape. The pair of sliding parts 16, 17 projects in the Z direction from the edges of the two side walls of cover 18, and extends in the X direction. The directions in which the pair of sliding parts 16, 17 projects are opposite to each other. The edge of sliding part 16 is opposite to the edge of sliding part 17. In connecting member 3 where cover part 18 is integrated with the pair of sliding parts 16, 17 in this manner, the section taken in the direction perpendicular to the X direction has a horizontally-inverted C shape or a C shape that has a hook at each edge.

The length of connecting member 3 along the X direction is set equal to or slightly longer than the total length, along the X direction, of the plurality of battery blocks 2 that form battery module 1. In the example of FIG. 1, two battery blocks 2 are connected. Thus, assuming the length of one battery block 2 along the X direction is defined as L₀, length L of connecting member 3 along the X direction is set slightly longer than 2L₀.

In the example described above, two battery blocks 2 are connected in the X direction. By increasing length L of connecting member 3, three or more battery blocks 2 can be connected and disposed in the X direction.

Connecting member 3 is fitted into guide grooves 14, 15 of two corresponding battery blocks 2 in the following manner. While the extending directions of guide grooves 14, 15 of two battery blocks 2 are aligned, sliding parts 16, 17 of connecting member 3 are slid in guide grooves 14, 15 from the end of battery module 1 so as to move along the X direction. As described above, the edge of sliding part 16 is opposite to the edge of sliding part 17. Further, the opening directions of guide grooves 14, 15 of two battery blocks 2 are opposite to each other. Thus, by fitting the pair of sliding parts 16, 17 into the pair of guide grooves 14, 15 of the plurality of battery blocks 2, respectively, the plurality of battery blocks 2 can be integrated and connected in the X direction without separating in the Z direction and the Y direction. Connecting member 3 and plurality of battery blocks 2 integrated with each other are fixed by a suitable fixing means, so as not to be separated in the X direction.

Connecting member 3 is disposed on the positive electrode side of battery block 2, and thus works as a duct for releasing gas exhausted from safety valves 9. FIG. 2 is a sectional view taken in a plane perpendicular to the X direction of FIG. 1(a).

Batteries 5 have lid 10 as a positive electrode-side insulating lid on the positive sides, and have positive electrode current collecting plate 12 on the outside of lid 10, i.e. on the opposite side of batteries 5. Between positive electrode current collecting plate 12 and lid 10, positive electrode lead plate 20 that has lead terminals connected to the positive electrode terminals of batteries 5 is disposed. Each of positive electrode current collecting plate 12 and positive electrode lead plate 20 is made of conductive plate material, such as metal. Lid 10 has openings corresponding to positive electrode terminals 7 of the 20 batteries 5. A lead terminal is inserted into each of the openings and connected to positive electrode terminal 7 by pressing contact or welding. Positive electrode lead plate 20 and positive electrode current collecting plate 12 are integrated by welding, for example, and fixed to lid 10 by a suitable fixing measure.

Similarly, batteries 5 have lid 11 as a negative electrode-side insulating lid on the negative sides, and have negative electrode current collecting plate 13 on the outside of lid 11, i.e. on the opposite side of batteries 5. Between negative electrode current collecting plate 13 and lid 11, negative electrode lead plate 21 having lead terminals connected to the negative terminals of battery 5 is disposed. Each of negative electrode current collecting plate 13 and negative electrode lead plate 21 is made of conductive plate material, such as metal. Lid 11 has openings corresponding to negative terminals 8 of the 20 batteries 5. A lead terminal is inserted into each of the openings and connected to negative electrode terminal 8 by pressing contact or welding. Negative electrode lead plate 21 and negative electrode current collecting plate 13 are integrated by welding, for example, and fixed to lid 11 by a suitable fixing measure. Thus, the 20 batteries 5 are connected in parallel by positive electrode current collecting plate 12 and negative electrode current collecting plate 13.

Connecting member 3 covers the ends of the positive electrode sides of battery blocks 2, and sliding part 16, 17 of the connecting member are hermetically joined to guide grooves 14, 15 of lids 10. This configuration forms duct space 24 in which gas can flow toward the ends of the positive electrode sides of battery blocks 2. The positive electrode side of each battery block 2 has safety valves 9; thus the exhaust gas from safety valves 9 can be released through duct space 24 from a predetermined exhaust port to the outside without leaking out from other parts. FIG. 1(a) shows flow 25 when exhaust gas is released, using the arrow outline with a blank inside.

In the above description, guide grooves 14, 15 are provided to lid 10 as a positive electrode-side insulating lid, but the guide grooves can be provided to lid 11 as a negative electrode-side insulating lid. Battery module 30 shown in FIG. 3 has the following element instead of lid 11 described with reference to FIG. 1 and FIG. 2. Lid 31 having a configuration the same as that of lid 10, i.e. the positive electrode-side insulating lid, is used as the negative electrode-side insulating lid. Lid 31 is a negative electrode-side insulating plate, and has guide grooves 32, 33. Guide grooves 32, 33 have configurations identical with those of guide grooves 14, 15 described with reference to FIG. 1 and FIG. 2. Connecting member 34 disposed on the negative electrode side corresponding to lids 31 includes a pair of sliding parts 35, 36 and cover part 37 similarly to connecting member 3 described with reference to FIG. 1 and FIG. 2. Connecting member 34 is not intended to form duct space 24 and is intended to cover negative electrode current collecting plate 13 and negative electrode lead plate 21. Thus, the dimension of connecting member 34 in the Y direction is smaller than that of connecting member 3.

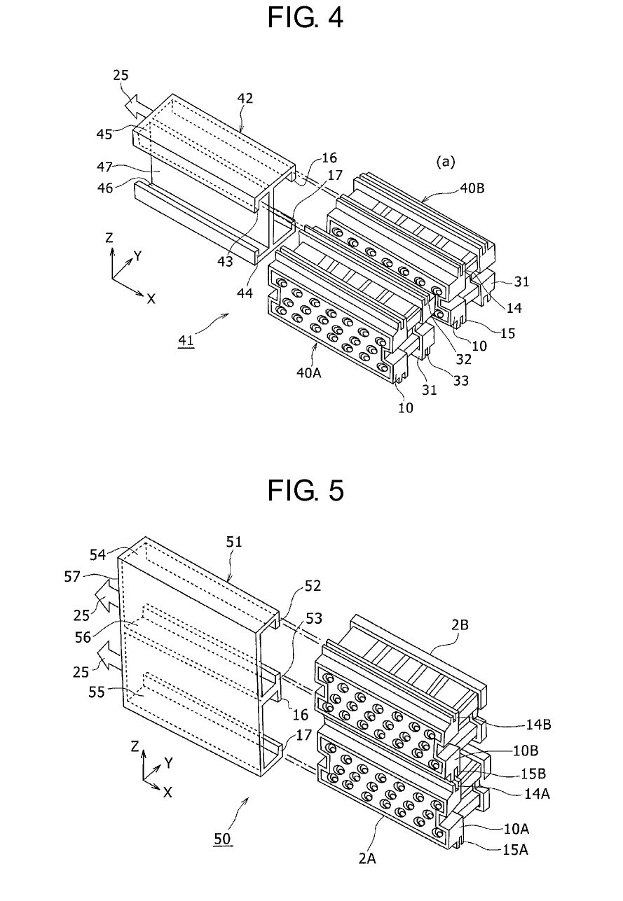

Suppose that the component obtained by removing connecting members 3, 34 from battery module 30 of FIG. 3 is battery block 40. FIG. 4 is a diagram showing battery module 41 in which two battery blocks 40A, 40B are disposed in the Y direction. Here, new connecting member 42 is used.

In addition to the pair of sliding parts 16, 17 described with reference to FIG. 1(d), connecting member 42 is further provided with a pair of sliding parts 43, 44. The pair of sliding parts 16, 17 is provided so as to be fitted into guide grooves 14, 15 of lid 10 of battery block 40B in two battery blocks 40A, 40B that are disposed adjacent to each other. This mechanism is the same as that of FIG. 1. In contrast, the other pair of sliding parts 43, 44 is provided so as to be fitted into guide groves 32, 33 of lid 31 of the other battery block 40A.

Connecting member 42 is configured of top plate 45 that connects sliding part 16 and sliding part 43, bottom plate 46 that connects sliding part 17 and sliding part 44, and connecting plate 47 that connects and integrates top plate 45 and bottom plate 46. Connecting member 42 has an H sectional shape taken in a plane perpendicular to the X direction. In the H shape, the portion that covers lid 10 of battery block 40B forms a duct space, and the portion that covers lid 31 of battery block 40A does not form a duct space. Thus, the sectional shape of connecting member 42 has an asymmetrical H shape. FIG. 4 shows flow 25 of the exhaust gas released by the duct space.

Two battery blocks 40A, 40B are aligned on the XY plane with a predetermined space provided between the two battery blocks so that guide grooves 32, 33, 14, 15 are parallel to each other. Then, sliding parts 43, 44, 16, 17 of connecting member 42 are slid along guide grooves 32, 33. 14, 15, respectively, and fitted therein. In this manner, using connecting member 42, two battery blocks 40A and 40B are disposed in the Y direction, and connected so as not to be separated into the Y direction or the Z direction. Thus, battery module 41 is formed. Using a plurality of connecting members 42 can provide a battery module in which a larger number of battery blocks 40 are disposed in the Y direction.

FIG. 5 is a diagram showing battery module 50 in which two battery blocks described with reference to FIG. 1 and FIG. 2 are disposed in the Z direction. In FIG. 5, two battery blocks 2 that are disposed adjacent to each other in the Z direction are distinguished and shown as battery blocks 2A, 2B. Here, new connecting member 51 is used.

In addition to the pair of sliding parts 16, 17 described with reference to FIG. 1(d), connecting member 51 further includes a pair of sliding parts 52, 53. The pair of sliding parts 16, 17 is used to be fitted into guide grooves 14A, 15A provided to lid 10A of one of battery blocks 2 in two battery blocks 2A and 2B that are disposed adjacent to each other. A newly provided pair of sliding parts 52, 53 is used to be fitted into guide grooves 14B, 15B provided to lid 10B of the other battery block 2B in two battery blocks 2A, 2B that are disposed adjacent to each other.

Connecting member 51 is configured of top plate 54 that has sliding part 52, bottom plate 55 that has sliding part 17, intermediate plate 56 that has sliding parts 16, 53, and connecting plate 57 that connects and integrates top plate 54, bottom plate 55, and intermediate plate 56. Connecting member 51 covers the positive electrode side of battery block 2A and the positive electrode side of battery block 2B so as to form a duct space. FIG. 5 shows flow 25 of the exhaust gas released by the duct space.

Two battery blocks 2A, 2B are aligned on the XZ plane with a predetermined space provided between the two battery blocks so that guide grooves 14A, 15A, 14B, 15B are parallel to each other. Then, sliding parts 16, 17, 52, 53 of connecting member 51 are slid along guide grooves 14A, 15A, 14B, 15B, respectively, and are fitted therein. In this manner, using connecting member 51, two battery blocks 2A and 2B are disposed in the Z direction and connected so as not to be separated into the Y direction or the Z direction. Thus, battery module 50 is formed. Increasing the number of intermediate plates 56 of connecting member 51 can provide a battery module in which a larger number of battery blocks 2 are disposed in the Z direction.

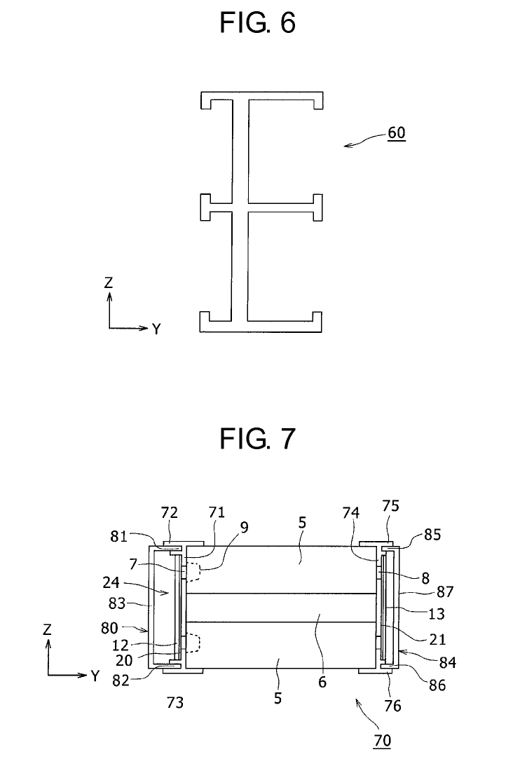

In the above description, a plurality of battery blocks 2 or a plurality of battery blocks 40 is connected in one of the X direction, the Y direction, and the Z direction. For instance, using connecting member 60 shown in FIG. 6, a plurality of battery blocks 40 can be connected and disposed in a plurality of directions of the X direction, the Y direction, and the Z direction.

In the above descriptions, the direction toward which the opening of the guide groove is oriented is defined as the Z direction. When the Z direction is a vertical direction, the opening of the guide groove may be opened toward the X direction, a horizontal direction orthogonal to the Z direction. One example thereof is shown as battery module 70 in FIG. 7. FIG. 7 is a diagram corresponding to FIG. 3. Lid 71 as the positive electrode-side insulating lid has guide grooves 72, 73 opened toward the X direction, which is a horizontal direction. Similarly, lid 74 as the negative electrode-side insulating lid has guide grooves 75, 76 opened toward the X direction. Correspondingly, connecting member 80 on the positive electrode side includes sliding parts 81, 82 projecting toward the X direction, i.e. a horizontal direction, and cover part 83 that connects the sliding parts. Connecting member 80 on the positive electrode side covers lid 71 as a positive electrode-side insulating lid, and forms duct space 24. Connecting member 84 on the negative electrode side includes sliding parts 85, 86 projecting toward the X direction, and cover part 87 that connects the sliding parts.

In the description of the above exemplary embodiment, safety valves 9 are provided in the vicinity of positive electrode terminals 7 of batteries 5 and connecting member 3 is disposed so as to cover lid 10 as the positive electrode-side insulating lid. However, safety valves 9 may be formed in the vicinity of negative electrode terminals 8 of batteries 5. In this case, duct space 24 for releasing the exhaust gas exhausted from safety valves 9 of batteries 5 needs to be formed on the negative electrode sides of battery blocks 2. In this case, duct space 24 is formed by each lid 11 as the negative electrode-side insulating lid; thus lid 11 has a shape larger than that of lid 10 as the positive electrode-side insulating lid.

### Second Exemplary Embodiment

FIG. 8 is a perspective view showing battery module 100 and battery blocks 102 forming the battery module in accordance with the second exemplary embodiment. Battery block 102 of the second exemplary embodiment corresponds to battery assembly 4 of the first exemplary embodiment. Thus, in the following description, a description is mainly provided for the difference of battery block 102 from battery assembly 4 of the first exemplary embodiment. In FIG. 8, (a) shows battery module 100, and (b) shows one of battery blocks 102. Battery module 100 is configured of a plurality of battery blocks 102, a plurality of types of cover members 103, 104, 105, fixing members 106, 107 for fixing battery blocks 102 through cover members 103, 104, 105, and fastening members 108, 109. Here, three battery blocks 102, four cover members 103, 104, 104, 105, and two fixing members 106, 107 are shown.

FIG. 8 shows the longitudinal direction and the line arrangement direction of batteries 5. Batteries 5 are longitudinally aligned with each other in a plurality of lines and in a plurality of columns. The direction in which a larger number of batteries are disposed is defined as a line arrangement direction. In FIG. 8, the direction in which six or seven batteries 5 are disposed is the line arrangement direction and the direction in which three batteries 5 are disposed is the column arrangement direction.

Safety valve 9 is provided in the vicinity of positive electrode terminal 7 of battery 5. Thus, on the positive electrode side of battery block 102, the gas exhaust outlets of safety valves 9 of batteries 5 are arranged and the exhaust gas from the inside of batteries 5 is released from the positive electrode side of battery block 102.

Corresponding to the positional relation of batteries 5, battery holding parts are arranged in a hound's-tooth pattern (a staggered (zigzag) pattern). Namely, three battery holding parts are disposed along the column direction, and seven, six, and seven battery holding parts are disposed along the line direction.

Therefore, the length in the direction of the battery holding parts in the central line is shorter than the length in the direction of the battery holding parts in the lines adjacent to the central line. Thus, at both ends along the line arrangement direction of battery case 6, recesses 1015, 1016 are formed as spaces where no batteries 5 are disposed. Each of recesses 1015, 1016 extends from one side to the other side along the longitudinal direction of batteries 5 and is recessed toward the portions where batteries 5 are disposed. Thus, recesses 1015, 1016 are through parts where no batteries 5 are disposed along the longitudinal direction of the plurality of batteries 5 at both ends of the line arrangement direction of batteries 5. Therefore, the through parts are not only recessed portions of battery case 6 as shown by recesses 1015, 1016, but also may be through holes formed in the positions of recesses 1015, 1016 in case 6.

Examples of such battery case 6 include a case made of plastic and formed into a predetermine shape. Alternatively, similarly to the first exemplary embodiment, such a case may be mainly made of aluminum, for example, and formed into a predetermine shape by extrusion molding or die casting.

As battery block 102, the following configuration may be used. Battery case 6 can be omitted, and a plurality of batteries 5 arranged in a hound's-tooth pattern (a staggered (zigzag) pattern) is fixed by a suitable insulating material or insulating sheet. Alternatively, only a plurality of batteries 5 arranged in a hound's-tooth pattern (a staggered (zigzag) pattern) may be fixed by positive electrode-side insulating plate 1020 and negative electrode-side insulating plate 1022, which will be described later. In this case, the through parts are configured as the portions where no batteries 5 are disposed in battery block 102.

Battery module 100 is configured so that the direction parallel to the longitudinal direction of each battery 5 is defined as the arrangement direction of battery blocks 102 and three battery blocks 102 are arranged. FIG. 8 shows the line arrangement direction of batteries 5, and the arrangement direction of battery blocks 102, i.e. the longitudinal direction of batteries 5. In FIG. 8 (a), three battery blocks 102 are distinguished and shown as battery blocks 102A, 102B, 102C. These battery blocks 102A, 102B, 102C are arranged so that the positions of recesses 1015, 1016, i.e. the through parts of three battery blocks are aligned along the arrangement direction of battery blocks 102.

Cover members 103, 104, 105 are disposed at both ends of corresponding battery blocks 102A, 102B, 102C disposed along the arrangement direction of battery blocks 102. That is, herein, cover members 103, 104, 105 are members disposed on the positive electrode side or the negative electrode side of corresponding battery blocks 102A, 102B, 103C, and have three types of shapes depending on the positions where the members are disposed.

Cover members 103, 105 are disposed on the corresponding ends of two battery blocks 102A, 102C of three battery blocks 102A, 102B, 102C disposed along the arrangement direction of battery blocks 102 in battery module 100. Cover member 103 is disposed on the positive electrode side of battery block 102A, and cover member 105 is disposed on the negative electrode side of battery block 102C. Since safety valves 9 are disposed on the positive electrode side of battery block 102, cover member 103 has a shape slightly larger than that of cover member 105 so that the former cover member covers the positive electrode side of battery block 102A and can form a duct space for releasing exhaust gas exhausted from safety valves 9.

Each of cover members 104 is disposed between adjacent battery blocks 102, and has a shape combining cover member 103 and cover member 105. Namely, a shape similar to cover member 105 covers the negative electrode side of one of adjacent battery blocks 102, and a shape similar to cover member 103 covers the positive electrode side of the other of adjacent battery blocks 102. In FIG. 8(a), three battery blocks 102A, 102B, 102C are disposed along the arrangement direction of battery blocks 102; thus adjacent battery blocks 102 are battery block 102A and battery block 102B, and battery block 102B and battery block 102C. Therefore, each cover 104 is disposed between battery block 102A and battery block 102B, and between battery block 102B and battery block 102C.

When viewed from the section parallel to the arrangement direction of battery blocks 102, each of cover members 103, 105 has a horizontally-inverted C shape or a C shape, and each of cover members 104 has an H shape. In the H shape, the spatial volume on the side where duct space 1024 is formed is larger than the spatial volume on the side where no safety valves 9 are disposed. Examples of such cover members 103, 104, 105 include metal material or plastic material that has a predetermined heat resistance and strength and is formed into a predetermined shape.

Fixing members 106, 107 are connecting members that fix three battery blocks 102 through four cover members 103, 104, 105. Three battery blocks 102 are disposed so that the positions of recesses 1015, 1016 are aligned along the arrangement direction of three battery blocks 102. Thus, fixing member 106 is disposed along recesses 1015 of three battery blocks, and fixing member 107 is disposed along recesses 1016 of three battery blocks. In this manner, the spaces of recesses 1015, 1016 are effectively used to fix battery blocks 102.

Fastening members 108, 109 are fixed at both ends of fixing members 106, 107 via cover members 103, 105, and used to fix three battery blocks 102 via four cover members 103, 104, 105 by fastening method, such as thread fastening. As such fastening members 108, 109, a bolt or a nut can be used.

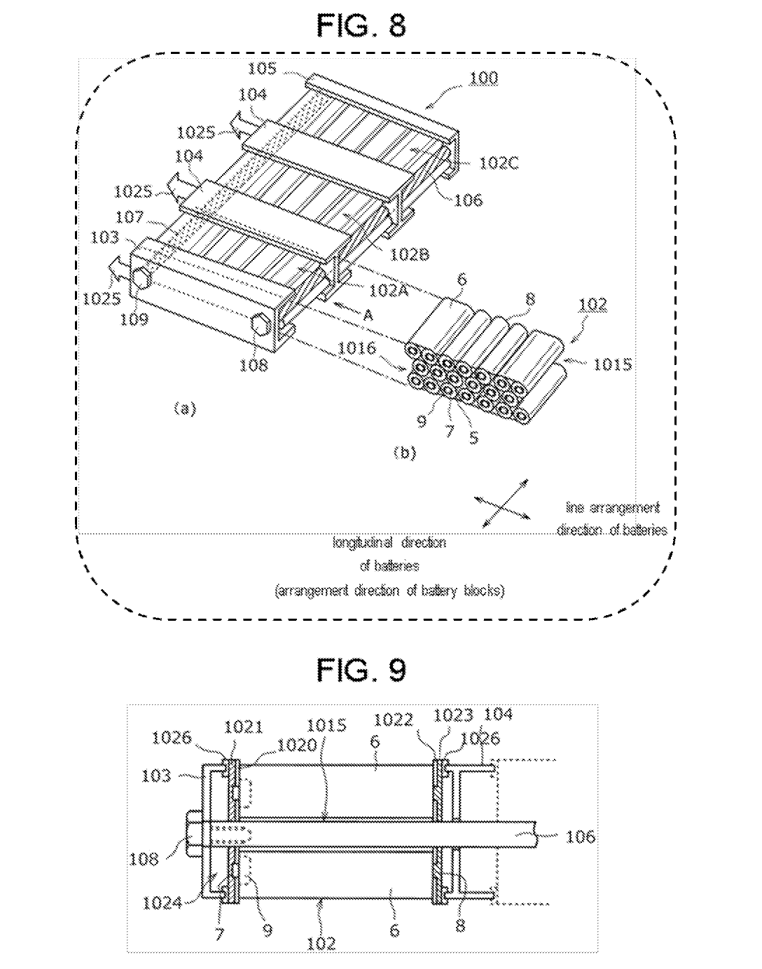

FIG. 9 is a sectional view seen from A direction in FIG. 8, and shows cover members 103, 104, recess 1015, fixing member 106, and fastening member 108.

On the positive electrode sides, batteries 5 have positive electrode-side insulating plate 1020, and positive electrode plate 1021 is disposed in contact with positive electrode terminals through 7 the positive electrode-side insulating plate. Similarly, on the negative electrode sides, batteries 5 have negative electrode-side insulating plate 1022, and negative electrode plate 1023 is disposed in contact with negative electrode terminals 8 through the negative electrode side-insulating plate. Cover members 103, 104 are connected via positive electrode plate 1021, negative electrode plate 1022, and insulating members 1026. Cover members 103, 104 are pressed to the sides of batteries 5. Thereby, positive electrode plate 1021 and positive electrode-side insulating plate 1020, and negative electrode plate 1023 and negative electrode-side insulating plate 1022 are closely fixed. Insulating members 1026 preferably have recesses into which the leg portions of cover members 103, 104 are fitted.

Cover member 103 is fixed to battery block 102, using fixing members 106 and fastening members 108. The cover member covers the end of the positive electrode side of battery block 102 and is hermetically joined to positive electrode-side insulating plate 1020 and battery case 6 so as to form duct space 1024 capable of releasing gas to the side of the end of the positive electrode side of battery block 102. With this configuration, the exhaust gas from safety valves 6 can be released through duct chamber 1024 from a predetermined exhaust port to the outside without leaking out from other parts. FIG. 8 shows flow 1025 of exhaust gas when released, using the arrow outline with a blank inside.

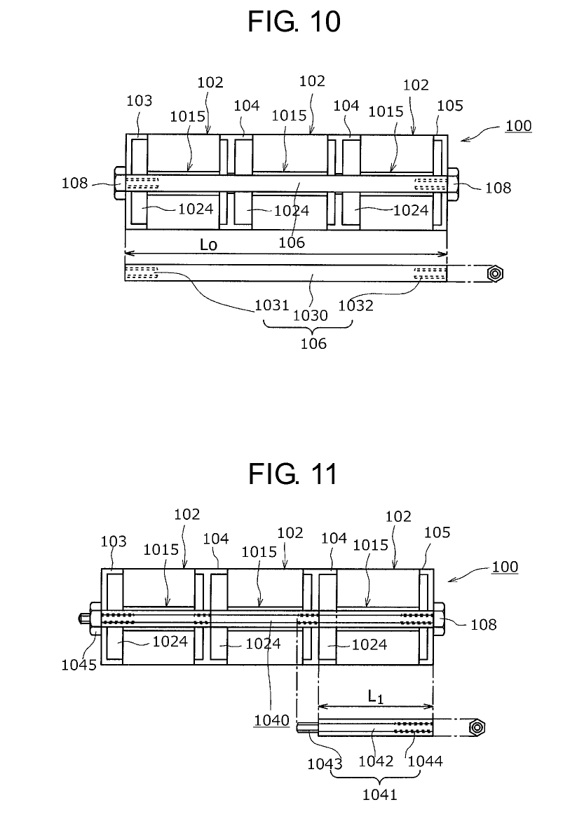

FIG. 10 is a detailed diagram of fixing member 106. Fixing member 107 has a configuration the same as that of fixing member 106. FIG. 10 is a sectional view seen from A direction of battery module 100, similarly to FIG. 9.

Fixing member 106 has length L₀ between both ends of battery module 100, and includes shaft body 1030 and fixing screw parts 1031, 1032 at both ends. Length L₀ between both ends of battery module 100 is a distance between the outermost end of cover member 103 and outermost end of cover member 105. In the configuration shown in FIG. 8 and FIG. 10, a bolt is used as fastening member 108. Thus, shaft body 1030 may have any configuration that includes a female screw at each end. For instance, a female screw may be formed at each end of solid round bar material. Alternatively, a female screw may be formed at each end of a hollow hole of hollow bar material. Examples of such fixing member 106 include metal rod material having a suitable strength and subjected to predetermined screw cutting.

A nut may be used as a fastening member. In this case, a male screw projects at each end of shaft body 1030.

FIG. 11 is a diagram showing fixing member 1040 in another configuration. FIG. 11 is a sectional view of battery module 100 seen from A direction, similarly to FIG. 10.

Fixing member 1040 is formed of three spacer rod members 1041. Each of spacer rod members 1041 has length L₁ between adjacent covers, and is configured of shaft body 1042 having a peripheral shape that can be tightened by turning, male screw 1043 provided on one end, and female screw 1044 provided on the other end. Length L₁ between adjacent covers is a length along the arrangement direction, and is a distance between the inner wall of the cover disposed on the positive electrode side and the inner wall of the cover disposed on the negative electrode side of one battery block 102.

Each spacer rod member 1041 is disposed between cover member 103 and adjacent cover member 104, between cover members 104 adjacent to each other, and between cover member 105 and adjacent cover member 104. In adjacent spacer rod members 1041, male screw 1043 of one spacer rod member 1041 is mated to female screw 1044 of the other spacer rod member 1041. Thereby, three spacer rod members 1041 form one fixing member 1040. In order to mate male screw 1043 and female screw 1044 in adjacent spacer rod members 1041, spacer rod members 1041 need to be tightened by being turned around the shafts thereof. In the example shown in FIG. 11, shaft body 1042 is configured of a hexagonal rod, and thus the spacer rod member can be tightened by being turned around the shaft, using a suitable hexagonal spanner. Other configurations may be used. For instance, the shaft body is a round rod, and a part thereof has a hexagonal shape. Other than the hexagonal shape, a square shape, for example, may be used. A hole for receiving a turning jig may be provided.

In the example of FIG. 11, the fastening member on the side of cover member 105 is a bolt, whereas fastening member 1045 on the side of cover member 103 is a nut. By reversing the installation direction of spacer rod members 1041, fastening member 108 can be exchanged with fastening member 1045.

In the description of the above exemplary embodiment, safety valves 9 are provided in the vicinity of positive electrode terminals 7 of batteries 5, cover member 103 is provided on the positive electrode side of corresponding battery block 12, and duct space 1024 is provided on the positive electrode side of each battery block 102. However, safety valves 9 may be formed in the vicinity of negative electrode terminals 8 of batteries 5. In this case, each duct space 1024 for releasing the exhaust gas exhausted from safety valves 9 of batteries 5 needs to be formed on the negative electrode side of battery block 102. In this case, duct space 1024 is formed by cover member 105; thus cover member 105 has a shape larger than that of cover member 103.

### REFERENCE MARKS IN THE DRAWINGS

1, 30, 41, 50, 70, 100 Battery module

2, 2A, 2B, 40, 40A, 40B, 102 Battery block

3, 34, 42, 51, 60, 80, 84 Connecting member

4 Battery assembly

5 Battery

6 Battery case

7 Positive electrode terminal

8 Negative electrode terminal

9 Safety valve

10, 10A, 10B, 11, 31, 71, 74 Lid

12 Positive electrode current collecting plate

13 Negative electrode current collecting plate

14, 14A, 14B, 15, 15A, 15B, 32, 33, 72, 73, 75, 76 Guide groove

16, 17, 35, 36, 43, 44, 52, 53, 81, 82, 85, 86 Sliding part

18, 37, 83, 87 Cover part

20 Positive electrode lead plate

21 Negative electrode lead plate

24 Duct space

25 Flow (of exhaust gas)

45, 54 Top plate

46, 55 Bottom plate

47, 57 Connecting plate

56 Intermediate plate

103, 104, 105 Cover member

106, 107, 1040 Fixing member

108, 109, 1045 Fastening member

1015, 1016 Recess (through part)

1020 Positive electrode-side insulating plate

1021 Positive electrode plate

1022 Negative electrode-side insulating plate

1023 Negative electrode plate

1024 Duct space

1026 Insulating member

1030, 1041 Shaft body

1031, 1032 Screw part

1041 Spacer rod member

1043 Male screw

1044 Female screw

1. A battery module comprising:
a plurality of battery blocks; and
a connecting member for aligning and connecting the plurality of battery blocks in a predetermined arrangement direction,
wherein each of the battery blocks includes:
a plurality of batteries longitudinally aligned with each other;
a battery case for arranging and holding the plurality of batteries;
an insulating lid disposed at positive electrode-side ends or negative electrode-side ends of the batteries in the battery case; and
at least a pair of guide grooves disposed on the insulating lid and extending in a direction parallel to each other, at least a pair of sliding parts provided to the connecting member being fitted into the guide grooves, and
the plurality of battery blocks is aligned in a direction in which each of the guide grooves extends, and the sliding parts of the connecting member are fitted into the corresponding guide grooves of the plurality of battery blocks, so that the sliding parts and the guide grooves are interconnected.

2. A battery module comprising:
a plurality of battery blocks; and
a connecting member for aligning and connecting the plurality of battery blocks in a predetermined arrangement direction,
wherein each of the battery blocks includes:
a plurality of batteries longitudinally aligned with each other;
a battery case for arranging and holding the plurality of batteries;
a positive electrode-side insulating lid, disposed at positive electrode-side ends of the batteries in the battery case, for insulating positive electrodes of the batteries from a positive electrode current collecting plate;
a negative electrode-side insulating lid, disposed at negative electrode-side ends of the batteries in the battery case, for insulating negative electrodes of the batteries from a negative electrode current collecting plate; and
at least a pair of guide grooves disposed on at least one of the positive electrode-side insulating lid and the negative electrode-side insulating lid and extending in a direction parallel to each other, at least a pair of sliding parts provided to the connecting member being fitted into the pair of guide grooves, and
the plurality of battery blocks is aligned in a direction in which each of the guide grooves extends, and the sliding parts of the connecting member are fitted into the corresponding guide grooves of the plurality of battery blocks, so that sliding parts and the guide grooves are interconnected.

3. The battery module of claim 1, wherein
each of the batteries has a safety valve,
each of the battery blocks has the safety valves of the batteries on a side of the positive electrode-side ends or a side of the negative electrode-side ends,
the connecting member covers the side of the positive electrode-side ends or the side of the negative electrode-side ends of the battery block where the safety valves of the batteries are arranged, and
the connecting member also works as a duct member that forms a duct space for releasing exhaust gas exhausted from the safety valves.

4. The battery module of claim 1, wherein
when the plurality of batteries is arranged on one plane in each of the plurality of battery blocks, a direction in which the plane extends is defined as an X direction, and
when the plurality of battery blocks is aligned in the X direction, the pair of guide grooves of each of the battery blocks is separated along the X direction parallel to each other, and the pair of sliding parts of the connecting member is separated along the X direction parallel to each other.

5. The battery module of claim 4, wherein
when the plurality of battery blocks is aligned in the X direction, and also in a Y direction orthogonal to the X direction and parallel to a longitudinal direction of the batteries, the pair of guide grooves is disposed both on the positive electrode-side insulating lid and the negative electrode-side insulating lid so that each of the battery blocks has two pairs of guide grooves, and
the connecting member is fitted into two of the pairs of guide grooves provided to opposed ends of the battery blocks that are adjacent to each other along the Y direction.

6. The battery module of claim 1, wherein when the plurality of battery blocks is aligned in the X direction and also in a Z direction orthogonal to the X direction and orthogonal to the longitudinal direction of the batteries, the connecting member is fitted into two of the pairs of guide grooves provided to opposed ends of the battery blocks that are adjacent to each other along the Z direction.

7. The battery module of claim 2, wherein
each of the batteries has a safety valve,
each of the battery blocks has the safety valves of the batteries on a side of the positive electrode-side ends or a side of the negative electrode-side ends,
the connecting member covers the side of the positive electrode-side ends or the side of the negative electrode-side ends of the battery block where the safety valves of the batteries are arranged, and
the connecting member also works as a duct member that forms a duct space for releasing exhaust gas exhausted from the safety valves.

8. The battery module of claim 2, wherein
when the plurality of batteries is arranged on one plane in each of the plurality of battery blocks, a direction in which the plane extends is defined as an X direction, and
when the plurality of battery blocks is aligned in the X direction, the pair of guide grooves of each of the battery blocks is separated along the X direction parallel to each other, and the pair of sliding parts of the connecting member is separated along the X direction parallel to each other.

9. The battery module of claim 4, wherein when the plurality of battery blocks is aligned in the X direction and also in a Z direction orthogonal to the X direction and orthogonal to the longitudinal direction of the batteries, the connecting member is fitted into two of the pairs of guide grooves provided to opposed ends of the battery blocks that are adjacent to each other along the Z direction.

10. The battery module of claim 8, wherein when the plurality of battery blocks is aligned in the X direction and also in a Z direction orthogonal to the X direction and orthogonal to the longitudinal direction of the batteries, the connecting member is fitted into two of the pairs of guide grooves provided to opposed ends of the battery blocks that are adjacent to each other along the Z direction.
